(19) United States
(12) Patent Application Publication
(10) Pub. No.: US 2006/0238486 A1
(43) Pub. Date: Oct. 26, 2006

(54) Liquid crystal display device suitable for display of moving pictures

(76) Inventor: Katsuyoshi Hiraki, Kawasaki (JP)

Correspondence Address: HARNESS, DICKEY & PIERCE, P.L.C., P.O. BOX 8910, RESTON, VA, 20195, US

(21) Appl. No.: 11/362,866

(22) Filed: Feb. 28, 2006

(30) Foreign Application Priority Data
Mar. 1, 2005 (JP) 2005-056486

(51) Int. Cl. G09G 3/36

(52) U.S. Cl. 345/102

(57) ABSTRACT

A back lighting has first and second back lighting units which respectively supply light to a first display region that has first gate lines of the liquid crystal display panel, and a second display region that has second gate lines, the liquid crystal control circuit unit performs, during the frame period, starting driving that drives the pixels at a first voltage corresponding to the image data, and hold driving that drives the pixels at a second voltage corresponding to the image data, successively for the first display region, and then performs the starting driving and hold driving successively for the second display region, and the first back lighting unit is lit after the starting driving of the first display region, while the second back lighting unit is lit after the starting driving in the second display region.

### CROSS-REFERENCE TO RELATED APPLICATIONS

This application is based upon and claims the benefit of priority from the prior Japanese Patent Application No. 2005-056486, filed on Mar. 1, 2005, the entire contents of which are incorporated herein by reference.

### BACKGROUND OF THE INVENTION

1 . Field of the Invention

The present invention relates to a liquid crystal display device which is suitable for the display of moving pictures, and more particularly relates to a liquid crystal display device in which the liquid crystal response speed is increased, and blurring of the moving pictures is suppressed.

2. Description of the Related Art

Liquid crystal display devices are widely used as space-saving flat type displays, and in recent years have begun to be used as television display devices. In liquid crystal display devices, a voltage corresponding to a brightness value is applied across electrodes between which a liquid crystal layer is sandwiched, and desired brightness values or colors are displayed by varying the transmissivity of the liquid crystal layer and thus controlling the amount of light that passes through the layer from back lighting. In conventional liquid crystal display devices, if images that vary from instant to instant such as moving pictures are displayed, this leads to blurring of the moving pictures, because of the slowness of the liquid crystal response speed and the use of the “hold” display principle in which desired brightness values or colors are displayed by holding the applied voltage for a specified period of time. In other words, since the state of the liquid crystal layer is varied while the back lighting is lit, the transitional states of the variation in transmissivity are also displayed, and this is sensed by the human eye as blurring of the moving pictures.

An overdrive system has been proposed as a method for accelerating the response speed of liquid crystals. However, even if the variation in the transmissivity of the liquid crystal layer is accelerated by means of such an overdrive system, blurring of the moving pictures cannot be eliminated in cases where the transitional states of the variation in transmissivity are lit by back lighting. Accordingly, an impulse driving system has been proposed in which the back lighting is lit after the variation in the transmissivity of the liquid crystal layer has been completed. In other words, in the impulse driving system, lighting of the back lighting is performed intermittently, and the back lighting is not lit while the transmissivity of the liquid crystal layer is undergoing variation, but is instead lit after this variation has been completed. For example, such an impulse driving system is disclosed in Japanese Patent Application Laid-Open No. 2003-131635 (issued on May 9, 2003).

### SUMMARY OF THE INVENTION

However, in the case of the impulse driving system, it is necessary to ensure a specified lighting period of the back lighting after the variation in the transmissivity of the liquid crystal layer has been completed. Accordingly, it is necessary to increase the speed of the variation in the transmissivity of the liquid crystal layer; consequently, it is necessary to increase the speed at which the voltage is applied to the liquid crystal layer. As a result of this, it is necessary to increase the transfer rate of image data to the data driver, and the problem of increase complexity of the control circuit construction arises. Furthermore, the abovementioned overdrive system-also becomes necessary in order to increase the speed of the variation in the transmissivity of the liquid crystal layer.

In the overdrive system, the start driving is initially performed at a first voltage that is higher (or lower) than the voltage corresponding to the image data; subsequently, hold driving is performed at a second voltage corresponding to the image data. Accordingly, voltage driving of the liquid crystal layer must be performed twice. This need to perform voltage driving twice requires that the driving time of the liquid crystal layer in the abovementioned impulse driving system be shortened, and that the transfer rate of image data to the data driver be increased. In cases where the driving time of the liquid crystal layer cannot be shortened, the stable period following the variation in the transmissivity of the liquid crystal layer within one frame is shortened, and the back-light lighting period becomes shorter, thus making it difficult to display images with a high brightness. Furthermore, in cases where the image data is temporarily stored in a frame memory, the speed at which this image data is read out from the frame memory must also be increased, and in this regard as well, the control circuit construction tends to become more complicated.

Accordingly, it is an object of the present invention to provide a liquid crystal display device which can suppress the blurring of moving pictures without raising the transfer rate of image data to the data driver.

In order to achieve the abovementioned object, a first aspect of the present invention is a liquid crystal display device in which a voltage corresponding to the image data is applied to the liquid crystal layer for each frame, and a transmissivity of this liquid crystal layer is varied to the transmissivity corresponding to the image data, wherein this liquid crystal display device comprises a liquid crystal display panel which contains the liquid crystal layer, and which also has a plurality of gate lines, a plurality of data lines, and pixels at the intersection positions of the gate lines and data lines, back lighting which supplies light that passes through the liquid crystal layer, and a liquid crystal control circuit unit which has a frame memory that stores image data corresponding to the frame, and which reads out image data from the frame memory and applies a voltage corresponding to the image data to the liquid crystal layer of pixels via the data lines.

Furthermore, the back lighting has first and second back lighting units which respectively supply light to a first display region that has first gate lines of the liquid crystal display panel, and a second display region that has second gate lines, the liquid crystal control circuit unit performs, during the frame period, starting driving that drives the pixels at a first voltage corresponding to the image data, and hold driving that drives the pixels at a second voltage corresponding to the image data, successively for the first display region, and then performs the starting driving and hold driving successively for the second display region, and the first back lighting unit is lit after the starting driving of the first display region, while the second back lighting unit is lit after the starting driving in the second display region.

In order to achieve the abovementioned object, a second aspect of the present invention is a liquid crystal display device in which a voltage corresponding to the image data is applied to the liquid crystal layer for each frame, and the transmissivity of this liquid crystal layer is varied to the transmissivity corresponding to the image data, wherein this liquid crystal display device comprises a liquid crystal display panel which contains the liquid crystal layer, and which also has a plurality of gate lines, a plurality of data lines, and pixels at the intersection positions of these gate lines and data lines, back lighting which supplies light that passes through the liquid crystal layer, and a liquid crystal control circuit unit which has a frame memory that stores image data corresponding to the frame, and which reads out image data from the frame memory and applies a voltage corresponding to the image data to the liquid crystal layer of pixels via the data lines.

Furthermore, the back lighting has first and second back lighting units which respectively supply light to a first display region that has first gate lines of the liquid crystal display panel, and a second display region that has second gate lines, the liquid crystal control circuit unit performs, during the driving period within the frame, starting driving that drives the pixels at a first voltage corresponding to the image data, and hold driving that drives the pixels at a second voltage corresponding to the image data, successively for the first display region, and then performs the starting driving and hold driving successively for the second display region, the first back lighting unit is lit after the starting driving in the first display region, while the second back lighting unit is lit after the starting driving in the second display region, and the liquid crystal control circuit unit further holds the voltages of the pixels of the first and second display regions during a holding period following the driving period within the frame period.

In order to achieve the abovementioned object, a third aspect of the present invention is a liquid crystal display device in which a voltage corresponding to the image data is applied to the liquid crystal layer for each frame, and the transmissivity of this liquid crystal layer is varied to the transmissivity corresponding to the image data, wherein this liquid crystal display device comprises a liquid crystal display panel which contains the liquid crystal layer, and which also has a plurality of gate lines, a plurality of data lines, and pixels at the intersection positions of these gate lines and data lines, back lighting which supplies light that passes through the liquid crystal layer, and a liquid crystal control circuit unit which has a frame memory that stores image data corresponding to the frame, and which reads out image data from the frame memory and applies a voltage corresponding to the image data to the liquid crystal layer of pixels via the data lines.

Furthermore, the back lighting has first through fourth back lighting units that respectively supply light to a first display region that has first gate lines of the liquid crystal display panel, a second display region that has second gate lines, a third display region that has third gate lines, and a fourth display region that has fourth gate lines, the liquid crystal control circuit unit performs, during the frame period, starting driving that drives the pixels at a first voltage corresponding to the image data, and hold driving that drives the pixels at a second voltage corresponding to the image data, in that order for the first display region, then performs the starting driving and hold driving in that order for the second display region, then performs the starting driving and hold driving in that order for the third display region, and then performs the starting driving and hold driving in that order for the fourth display region, and the first through fourth back lighting units are respectively lit following the respective starting driving in the first through fourth display regions.

In order to achieve the abovementioned object, a fourth aspect of the present invention is a liquid crystal display device in which a voltage corresponding to the image data is applied to the liquid crystal layer for each frame, and the transmissivity of this liquid crystal layer is varied to the transmissivity corresponding to the image data, wherein this liquid crystal display device comprises a liquid crystal display panel which contains the liquid crystal layer, and which also has a plurality of gate lines, a plurality of data lines, and pixels at the intersection positions of these gate lines and data lines, back lighting which supplies light that passes through the liquid crystal layer, and a liquid crystal control circuit unit which has a frame memory that stores image data corresponding to the frame, and which reads out image data from the frame memory and applies a voltage corresponding to the image data to the liquid crystal layer of pixels via the data lines.

Furthermore, the back lighting has first through fourth back lighting units that respectively supply light to a first display region that has first gate lines of the liquid crystal display panel, a second display region that has second gate lines, a third display region that has third gate lines, and a fourth display region that has fourth gate lines, the liquid crystal control circuit unit performs, during the frame period, starting driving that drives the pixels at a first voltage corresponding to the image data, and hold driving that drives the pixels at a second voltage corresponding to the image data, in that order for the first and second display regions, and then performs the starting driving and hold driving in that order for the third and fourth display regions, and the first through fourth back lighting units are respectively lit following the respective starting driving in the first through fourth display regions.

The abovementioned aspects of the present invention make it possible to drive the liquid crystal layer by an overdrive system without increasing the readout rate of image data from the frame memory or increasing the transfer rate of image data to the data driver, and also make it possible to lengthen the lighting period of the back lighting. Accordingly, an image display with a high image quality can be obtained while suppressing the blurring of moving pictures.

### BRIEF DESCRIPTION OF THE DRAWINGS

FIG. 1 is a schematic structural diagram of the liquid crystal display device;

FIG. 2 is a partial structural diagram of the liquid crystal display device in the present embodiment;

FIG. 3 is a diagram showing the driving control of a general liquid crystal display device;

FIG. 4 is a diagram showing driving control by the overdrive system;

FIG. 5 is diagram showing another example of driving control by the overdrive system;

FIG. 6 is a diagram showing driving control using impulse driving of the back lighting in the overdrive driving control shown in FIG. 4;

FIG. 7 is a diagram showing driving control using separate driving of the back lighting in the overdrive driving control shown in FIG. 5;

FIG. 8 is a diagram showing the first driving control of the liquid crystal display panel in the present embodiment;

FIG. 9 is a diagram showing the second driving control of the liquid crystal display panel in the present embodiment;

FIG. 10 is a diagram showing the third driving control of the liquid crystal display panel in the present embodiment;

FIG. 11 is a diagram showing the fourth driving control of the liquid crystal display panel in the present embodiment;

FIG. 12 is a diagram showing the fifth driving control of the liquid crystal display panel in the present embodiment; and

FIG. 13 is a diagram showing the sixth driving control of the liquid crystal display panel in the present embodiment.

### DESCRIPTION OF THE PREFERRED EMBODIMENTS

Embodiments of the present invention will be described below with reference to the attached figures. However, the technical scope of the present invention is not limited to these embodiments; this scope extends to the matters described in the Claims, and equivalent matters thereof.

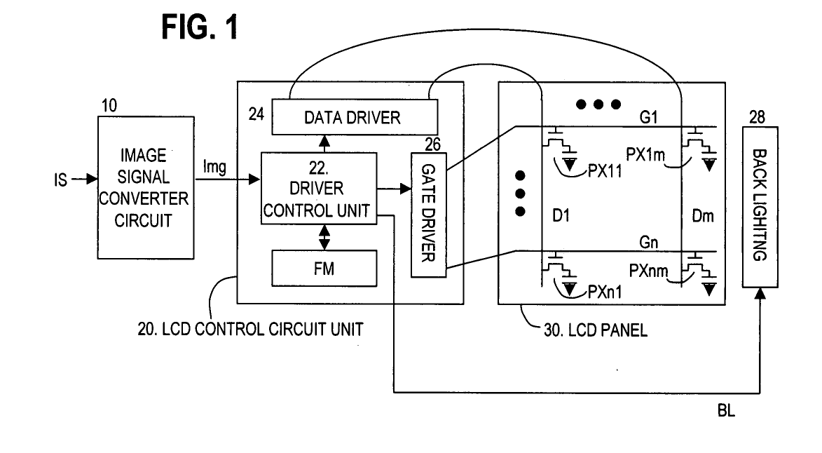

FIG. 1 is a schematic structural diagram of the liquid crystal display device. The liquid crystal display device is constructed from an image signal converter circuit 10, a liquid crystal control circuit unit 20, and a liquid crystal display panel 30. The image signal converter circuit 10 converts an image source signal IS from a personal computer, television tuner or the like into an image signal Img for each pixel corresponding to the liquid crystal display panel, e.g., in terms of panel size, pixel density and the like. The liquid crystal control circuit unit 20 temporarily stores the image data signals Img that are supplied in a frame memory FM. A driver control unit 22 reads out the image data from the frame memory FM in accordance with the display timing, supplies this image data to a data driver 24, and controls the driving of the gate lines by means of a gate driver 26 in accordance with the display timing.

The liquid crystal display panel 30 has a plurality of gate lines G1 through Gn that extend in the row direction, a plurality of data lines D1 through Dm that extend in the column direction, and pixels PX11 through PXnm each consisting of selection transistor and pixel electrode at the intersection positions of the gate lines and data lines. A driving voltage corresponding to the image data is applied to the pixel electrode via the data line and selection transistor of the pixel. The liquid crystal layer is sandwiched between the pixel electrode and a common electrode; the voltage that is applied to the pixel electrode varies the transmissivity of the liquid crystal layer to a transmissivity that corresponds to this voltage. Furthermore, back lighting 28 is installed in the liquid crystal display panel 30, and this back lighting is lit in response to a back lighting driving signal BL, so that light is supplied to the liquid crystal layer. The light of this back lighting passes through the layer to the display surface side in accordance with the transmissivity of the liquid crystal layer, so that a desired display brightness is output.

The data driver 24 of the liquid crystal control unit 20 drives the data lines D1 through Dm at specified voltages corresponding to the image data signals Img read out from the frame memory FM, and the gate driver 26 drives the gate lines so that the selection transistors of the row in question are simultaneously caused to become conductive, thus causing the voltage applied to the data lines to be applied to the pixel electrodes. Accordingly, as a result of the gate lines being successively driven, a voltage corresponding to the image data is successively applied to the pixels on the display line.

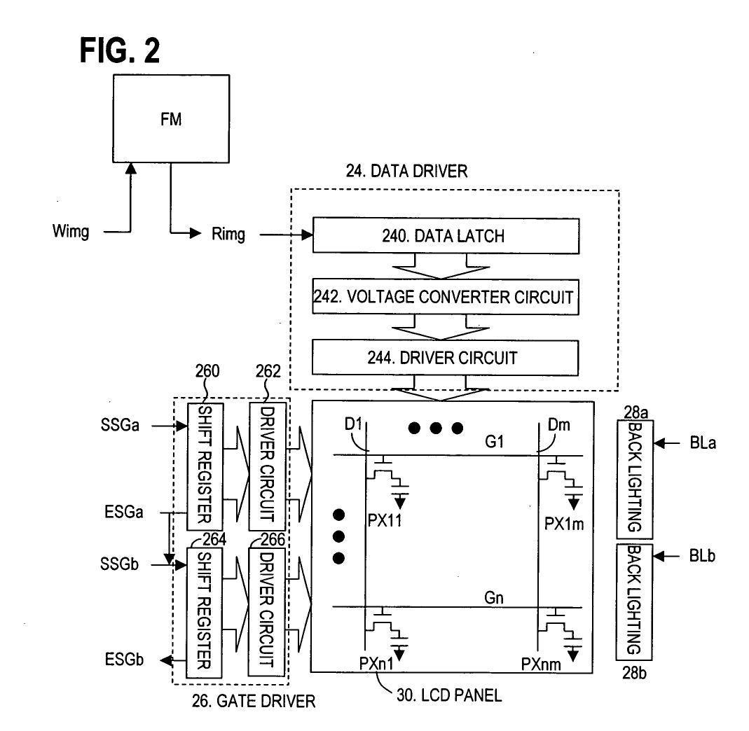

FIG. 2 is a partial structural diagram of the liquid crystal display device in the present embodiment. The data driver 24 and gate driver 26 are shown in detail in this structural diagram. The driver control unit 22 shown in FIG. 1 writes the image data supplied from the image signal converter circuit 10 into the frame memory FM as write image data Wimg, reads out image data Riumg from the frame memory FM in accordance with the driving timing, and supplies this image data to the data driver 24. The data driver 24 has a latch circuit 240 which latches read image data Rimg that is successively supplied line by line, a voltage converter circuit 242 which converts one line of image data Rimg into one line of driving voltage, and a driver circuit 244 which drives the data lines D1 through Dm using the converted voltage. Furthermore, the driver control unit 22 has shift registers 260 and 264, and driver circuits 262 and 266 that drive the gate lines G1 through Gn in response to signals from the shift registers. In response to a start signal SSGa from the driver control unit 22, the shift register 260 successively shifts the data “1” in the vertical direction; furthermore, the driver circuit 262 drives the corresponding gate line in response to the data “1” of the shift register. After performing a successive shift in the vertical direction, the shift register 260 outputs an end signal ESGa. Furthermore, in response to the abovementioned end signal ESGa or a start signal SSGb from the driver control unit 22, the shift register 264 successively shifts the data “1” in the vertical direction, and in response to this, the driver circuit 266 drives the corresponding data line. At the end of the shift operation, the shift register 264 outputs an end signal ESGb.

In the example shown in FIG. 2, the liquid crystal display panel 30 is separated into a first display region in the upper half, and a second display region in the lower half. Furthermore, the back lighting is separated into first back lighting 28a that supplies light to the first display region, and second back lighting 28b that supplies light to the second display region. Furthermore, in cases where the end signal ESGa is supplied to the shift register 264 on the lower side as a start signal SSGb, the driver control unit 22 can cause the shift registers 260 and 264 to operate as a single shift register connected in series merely by supplying the start signal SSGa, so that driving control of the gate lines can be performed within one frame period. On the other hand, in cases where start signals SSGa and SSGb are separately supplied to the respective shift registers 260 and 264, the driver control unit 22 can control the gate line driving in the first and second display regions separately. Furthermore, the driver control unit 22 can perform lighting control of the back lighting 28a and 28b either simultaneously or separately by means of the back lighting driving signals BLa and BLb.

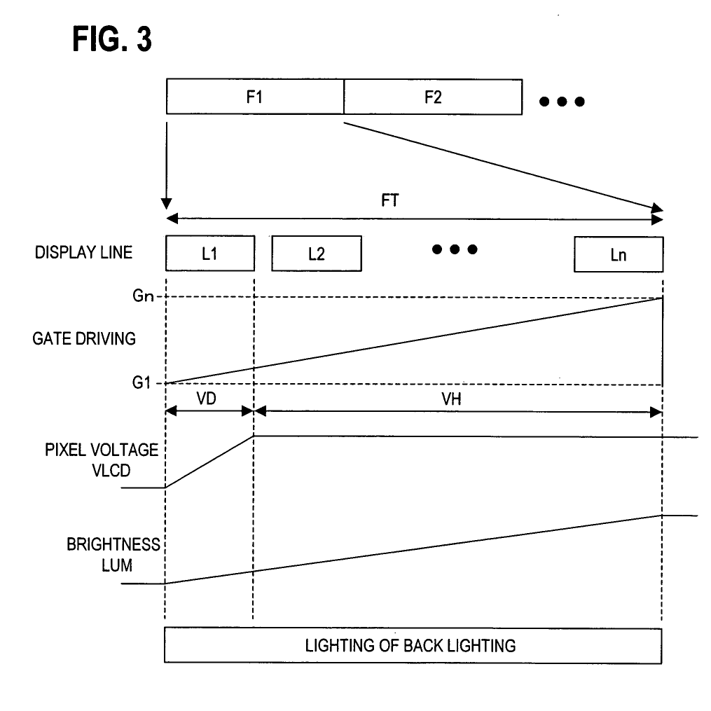

FIG. 3 is a diagram which shows the driving control of a general liquid crystal display device. In this example, in the respective frames F1 and F2, a pixel driving voltage VLCD is applied to the data lines D1 through Dm for the respective sets of image data corresponding to the display lines L1 through Ln (among the image data successively supplied line by line), and the corresponding gate lines G1 through Gn are driven. Accordingly, during the frame period FT, the gate lines from the gate line G1 to the gate line Gn are successively driven, and a pixel voltage VLCD corresponding to the image data is applied to the data lines D1 through Dm in synchronization with the driving of these gate lines. A pixel voltage VLCD is applied to the liquid crystal layer of the pixels within the display line L1 during the voltage driving period VD, and the voltage is held at this pixel voltage during the subsequent voltage holding period VH. Then, in the liquid crystal layer of the pixels, its transmissivity varies in accordance with the voltage application, and the brightness LUM also varies.

In the example shown in FIG. 3, since the pixel voltage VLCD is applied to the pixels during the frame period FT, it is necessary that the transmissivity of the liquid crystal layer varies to a desired transmissivity within the frame period FT. In other words, the transmissivity of the pixels reaches the desired transmissivity, so that the desired brightness value is reached, only at the end of the frame period FT. Accordingly, during the frame period FT, the liquid crystal layer of the pixels is in a transition state in which the transmissivity is varying, and if the back lighting continues to be lit during this period FT, light will pass through the layer in accordance with the transmissivity of the transition state of the liquid crystal layer, thus causing the blurring of moving pictures.

In the example shown in FIG. 3, in cases where the response speed of the liquid crystal layer is slow, there may be cases in which the variation in the transmissivity is not completed within one frame period FT, so that the desired brightness value cannot be obtained. Especially in cases where the variation in the pixel voltage VLCD is large, e.g., in cases where there is a variation from a black display to a white display or the like, the variation in the transmissivity of the liquid crystal layer may not occur in time. In such cases, driving by means of the overdrive system indicated below is effective.

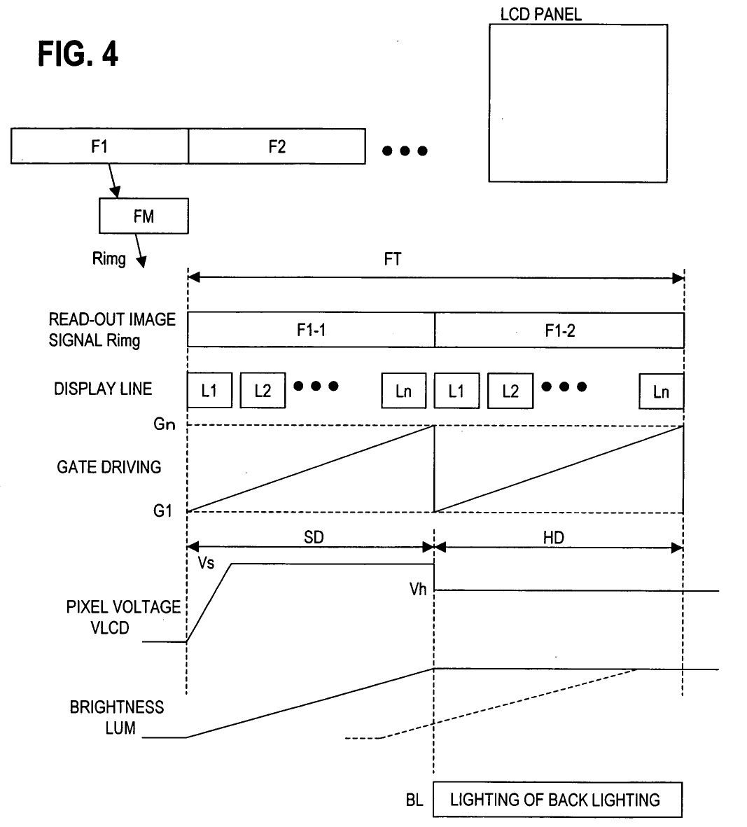

FIG. 4 is a diagram showing driving control by means of the overdrive system. In this example, image data of the respective frames F1 and F2 is temporarily stored in the frame memory FM, image data Rimg is read out from this frame memory FM, and the data lines are driven by a driving voltage corresponding to this read-out image data Rimg for each display line. Since the image data is stored in the frame memory FM, the display panel can be driven twice for a display within a single frame period FT by controlling the timing at which the image data Rimg is read out from the frame memory. However, it is necessary that the read-out speed of the image data from the frame memory FM and the transfer speed of the image data to the data driver be doubled.

First, in the first half of the frame period FT, all of the pixels are driven by an overdrive voltage Vs that is larger (or smaller) than the voltage corresponding to the image data Rimg while all of the gate lines G1 through Gn are successively driven. This is the start driving SD. Then, in the second half of the frame period FT, all of the pixels are driven by a voltage Vh corresponding to the image data Rimg (or a voltage obtained by finely adjusting this voltage Vh) while all of the gate lines G1 through Gn are again successively driven. This is the hold driving. As a result of such overdriving being performed, the respective pixels are driven by the start voltage Vs in the start driving SD, so that the liquid crystal layer of the respective pixels quickly varies to the desired transmissivity, thus making it possible to vary the brightness to the desired brightness LUM. Furthermore, in the hold driving HD, the respective pixels are driven by the hold voltage Vh, and are maintained in this hold voltage state, so that the liquid crystal layer is maintained at the desired transmissivity.

Thus, in the overdrive system, the liquid crystal layer of the respective pixels can be caused to vary to the final target transmissivity in a short time, so that the response speed of the liquid crystal can be increased, and the brightness values of the pixels can be securely varies within one frame period FT. Here, as is indicated by the solid line for the brightness LUM, the brightness of the first row line L1 within the display panel reaches the desired value at the point in time equal to ½ of the frame period FT; however, as is indicated by the broken line, the brightness of the final row line Ln of the display panel reaches the desired value only at the final point in time of the frame period FT. In other words, for the pixels of all of the row lines of the display panel, the brightness values vary over one frame period FT. Accordingly, if the back lighting is lit during the frame period FT, the pixels of some row lines will have a transmissivity in the transitional state, so that the problem of blurring of moving pictures is fundamentally insoluble.

In the driving control shown in FIG. 4, it is envisaged that the back lighting is lit only during the latter half of the fame period FT in accordance with the impulse driving system. In this case, the hold state is lit for the pixels of the first row line L1; accordingly, the blurring of moving pictures is eliminated. However, in the case of the pixels of the last row line Ln, the transitional state is lit; accordingly, the blurring of moving pictures is not eliminated here. In other words, within one frame period FT, the transmissivity is in the transitional state in one row line or the other, so that the blurring of moving pictures cannot be completely resolved even if the impulse driving system is utilized.

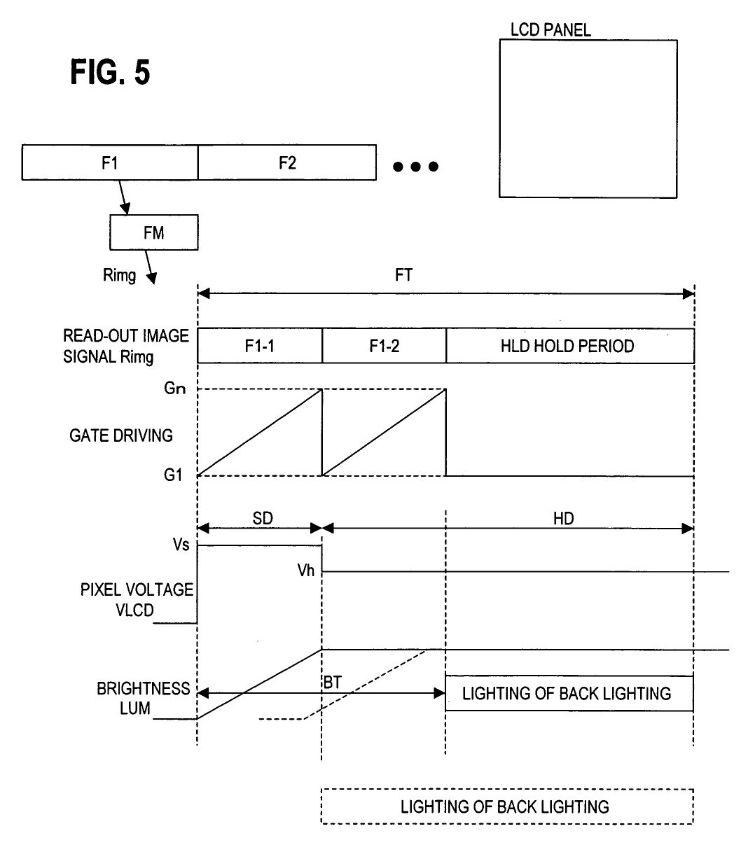

FIG. 5 is a diagram showing another type of driving control by the overdrive system. In this driving control, the read-out speed of the image data from the frame memory FM is quadrupled, and start driving SD is performed using the start voltage Vs for the respective pixels while the gate lines are successively driven during a period FT/4 equal to ¼ of the frame period FT. In the next period FT/4, hold driving HD using the hold voltage Vh is performed for the respective pixels while again successively driving the gate lines. Then, in the latter half of the frame period, the respective pixels are maintained at the hold voltage Vh. In this method, the liquid crystal layer varies over a period FT/4 which is ¼ of one frame; accordingly, the response speed of the liquid crystal layer is quadrupled. As a result, the liquid crystal layer of the pixels in the final line also completes the variation in transmissivity over a period of FT/2, as indicated by the broken line of the brightness LUM. Then, in the latter half of the frame period FT, since the brightness value LUM of all of the pixels reaches the desired value, a display with no blurring of moving pictures can be realized by lighting the back lighting only in the later half of this period. In other words, in the former half of the frame period FT, the transmissivity of some of the pixels is in a transitional state, so that this period is a blurring period BT. On the other hand, in the latter half of the frame period FT, the transmissivity of all of the pixels is in a hold state. Accordingly, the blurring of moving pictures can be eliminated by using impulse driving in which the back lighting is lit only during this latter half. However, since the back lighting is lit for only half of the frame period, a drop in the brightness of the display panel cannot be avoided. If the lighting period of the back lighting is lengthened as indicated by broken line, this causes the blurring of moving pictures, since the pixels of the display lines Gn/2 through Gn in the lower half of the display region are in a transitional state.

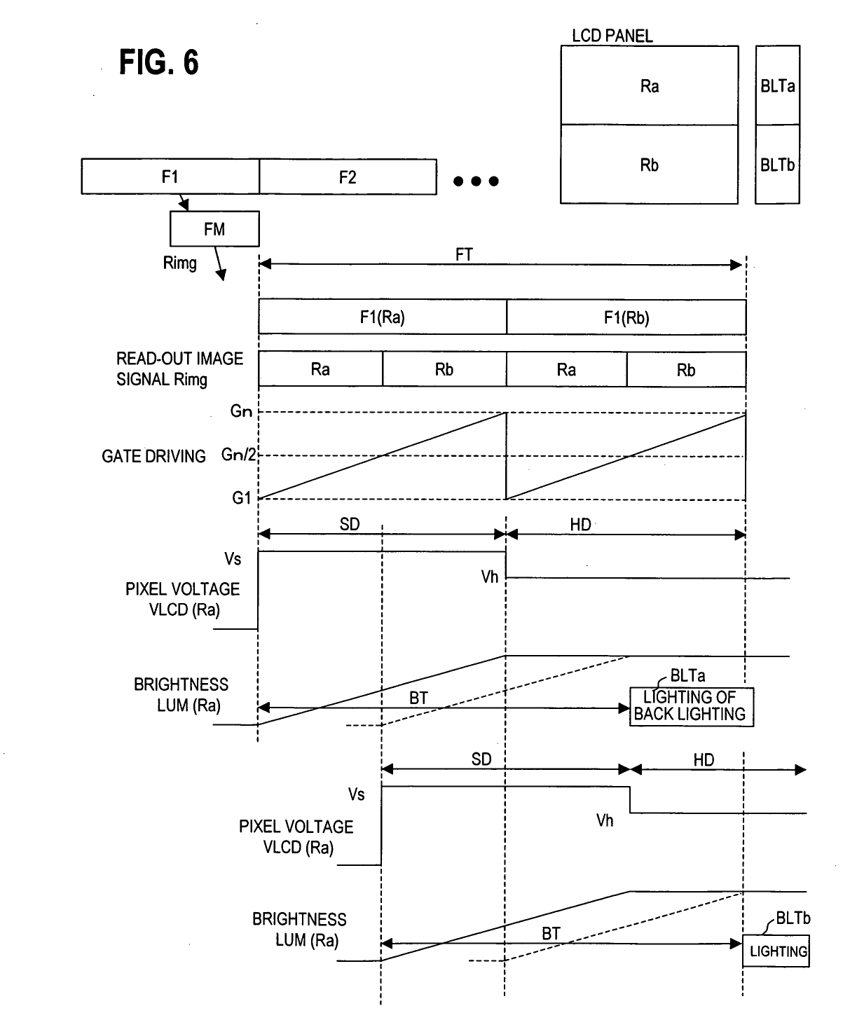

FIG. 6 is a diagram showing driving control using impulse driving of the back lighting in the overdrive driving control shown in FIG. 4. In this example, as is shown in the upper right portion of the figure, the liquid crystal display panel is divided into a first display region Ra and second display region Rb, first and second back lighting units BLTa and BLTb that supply light separately to the first and second display regions Ra and Rb are provided, and the first and second back lighting units BLTa and BLTb are subjected to individual lighting control.

First, in the former half of the frame period FT, the respective pixels within the first and second display regions Ra and Rb are driven by the overdrive voltage which is the start voltage Vs while all of the gate lines G1 through Gn are successively driven. Furthermore, in the latter half of the frame period FT, the respective pixels within the first and second display regions Ra and Rb are driven by the hold voltage Vh while all of the gate lines G1 through Gn are again successively driven. Up to this point, this operation is the same as that in FIG. 4. In other words, if one frame is used as a reference, then the speed at which the image data Rimg is read out from the frame memory FM is doubled, so that the response speed of the liquid crystal layer is also doubled.

Furthermore, in FIG. 6, after all of the start driving SD of the first display region Ra is completed (i.e., from the point in time at which the variation in the brightness LUM indicated by a broken line in FIG. 6 is completed), the first back lighting unit BLTa is lit. In other words, the first back lighting unit BLTa is lit during the final quarter of one frame period FT. Similarly, the second back lighting unit BLTb is lit for a period of FT/4 following the time at which all of the start driving SD of the second display region Rb is completed. Thus, by separating the back lighting into two parts, and performing intermittent lighting control, it is possible to light the back lighting separately after the transmissivity of the liquid crystal layer of the pixels in the two display regions Ra and Rb has been completely changed, so that the blurring of moving pictures can be eliminated. However, since the response speed of the liquid crystal layer is slow, the blurring period BT may be as much as ¾ of one frame period FT; accordingly, since the lighting period of the back lighting is short, i.e., ¼, a high-brightness display cannot be performed.

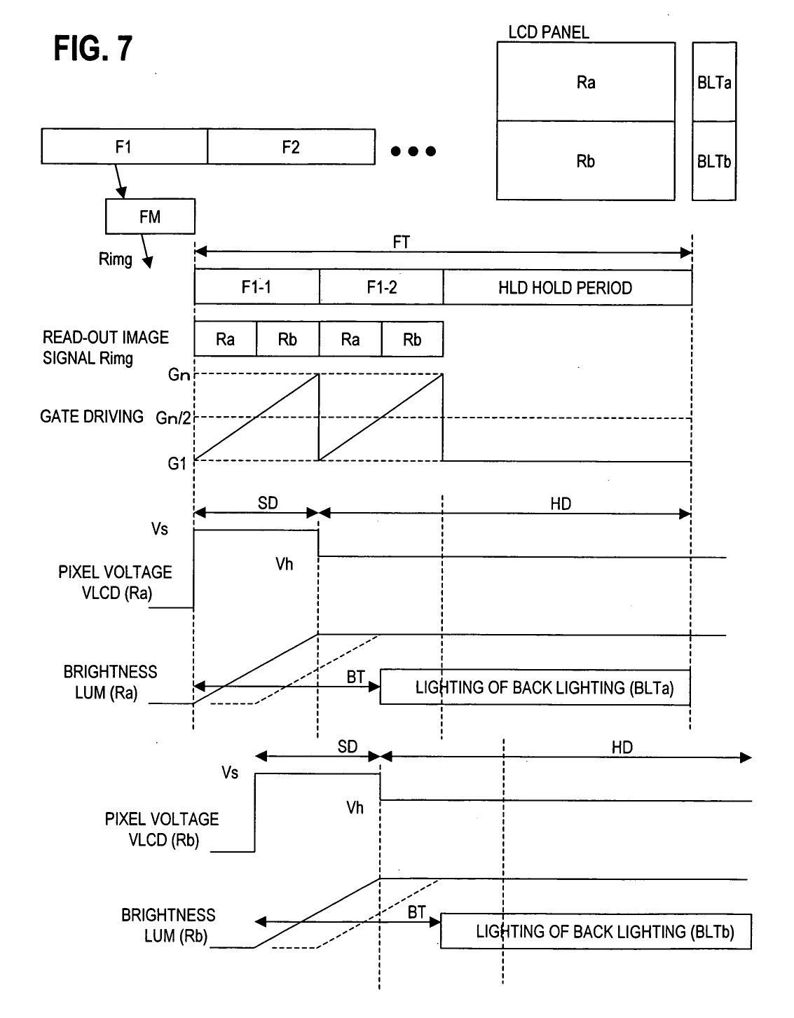

FIG. 7 is a diagram showing driving control which uses separate driving of the back lighting in the overdrive driving control shown in FIG. 5. In this example as well, as is shown in the upper right portion of the figure, the liquid crystal display panel is divided into first and second display regions Ra and Rb, and first and second back lighting units BLTa and BLTb are controlled by separate lighting control for these respective display regions.

First, during the initial period of FT/4 of the frame period FT, the respective pixels of the first and second display regions Ra and Rb are subjected to start driving SD at the start voltage Vs while all of the gate lines G1 through Gn are successively driven. Subsequently, the respective pixels of the first and second display regions Ra and Rb are driven at the hold voltage Vh while all of the gate lines G1 through Gn are again successively driven. Then, in the latter half FT/2 of the frame period FT, the liquid crystal state of all of the pixels is held. In other words, if one frame is used as a reference, the read-out speed of the image data Rimg from the frame memory FM is quadrupled, and since the liquid crystal layer must vary during a period of FT/4, the response speed is also quadrupled.

Furthermore, in FIG. 7, the first back lighting unit BLTa is lit from the time at which all of the start driving SD of the first display region Ra is completed (i.e., from the point in time at which the variation of the brightness LUM indicated by the broken line in FIG. 7 is completed). In other words, the first back lighting unit BLTa is lit for a period of ⅝ of one frame period FT. Similarly, the second back lighting unit BLTb is lit for a period of 5 FT/4 from the time at which all of the start driving SD of the second display region Rb is completed. Thus, by separating the back lighting into two parts, it is possible to lengthen the lighting period of the back lighting to 5 FT/8 from the FT/2 shown in FIG. 5. In other words, the blurring period BT in which the liquid crystal layer of some of the pixels is in a transitional state cam be shortened to ⅜ of 1 frame (3 FT/8).

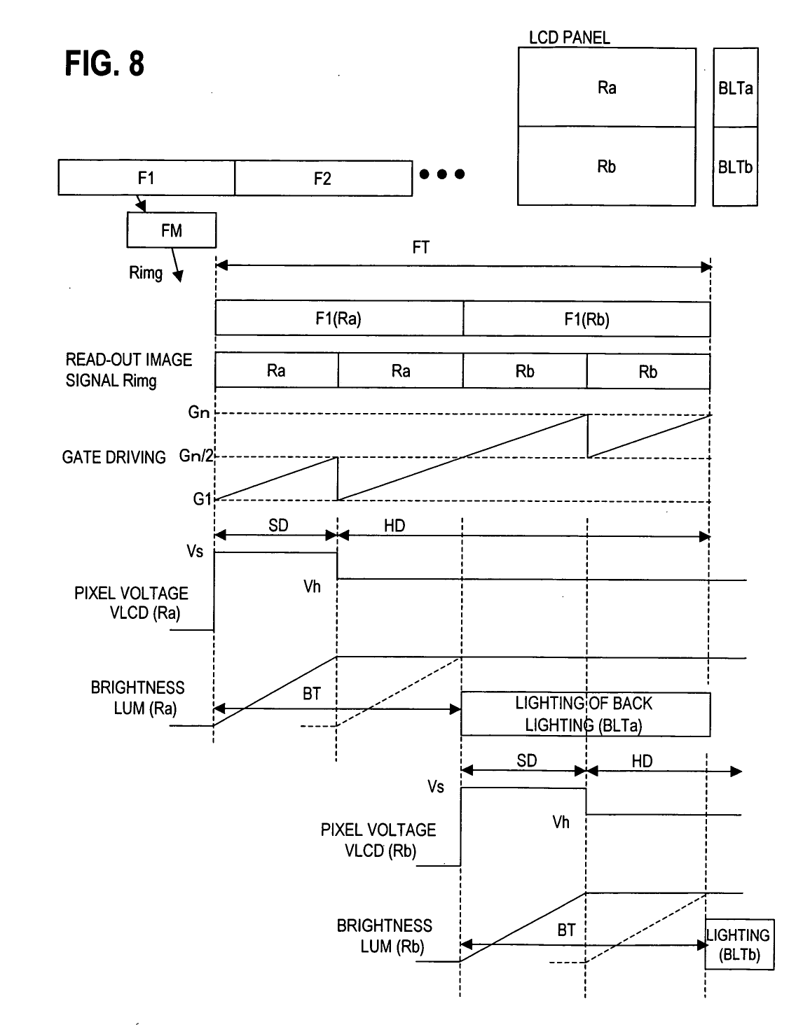

FIG. 8 is a diagram showing the first driving control of the liquid crystal display panel in the present embodiment. In this example, as is shown in the upper right portion of FIG. 8, the liquid crystal display panel is divided into fist and second display regions Ra and Rb, and first and second back lighting units BLTa and BLTb are subjected to separate lighting control for these respective display regions. Furthermore, in the former half of the frame period FT, the start voltage driving SD and the hold voltage driving HD are performed for the first display region Ra, while in the latter half of the frame period FT, the start voltage driving SD and the hold voltage driving HD are performed for the second display region Rb. In other words, in the former half of the frame period FT, start driving SD in which the pixels are driven at the start voltage Vs corresponding to the read-out image data Rimg while all of the gate lines G1 through Gn/2 in the first display region Ra are successively driven, and hold driving HD in which the pixels are driven at the hold voltage Vh while all of the gate lines G1 through Gn/2 in the first display region Ra are again successively driven, are successively performed. Subsequently, in the latter half of the frame period FT, start driving SD in which the pixels are driven at the start voltage Vs corresponding to the read-out image data Rimg while all of the gate lines Gn/2 through Gn in the second display region Rb are successively driven, and hold driving HD in which the pixels are driven at the hold voltage Vh while all of the gate lines Gn/2 through Gn in the second display region Rb are again successively driven, are successively performed. Then, lighting control of the respective back lighting units BLTa and BLTb is performed after the start driving SD of all of the pixels in the respective display regions Ra and Rb has been completed. In other words, lighting of the back lighting unit BLTa in the region Ra is performed in the latter half of the frame period FT, and lighting of the back lighting unit BLTb in the region Rb is performed in the former half of the frame period FT.

As a result, the rate of variation of the liquid crystal layer can be quadrupled (the variation in the brightness LUM is completed in a period of ¼ of one frame) with the read-out speed of the image data Rimg from the frame memory FM doubled (the image data Rimg is read out twice within one frame period). Accordingly, the blurring period BT can be reduced to FT/2, and the lighting period of the back lighting for the respective display regions Ra and Rb can be set at FT/2.

The operation and effect of this are clear in comparison with the driving control shown in FIG. 6. In other words, with the read-out speed of the image data from the frame memory FM and the transfer speed of this data to the data driver respectively remaining doubled, the response speed of the liquid crystal layer can be quadrupled (the period of the start driving SD is FT/4), and the blurring period BT which is the period up to the point where the variation in the brightness values of all of the pixels within the display region is completed can be shortened (to FT/4). Furthermore, the lighting of the back lighting can also be performed beginning at end of the transitional period of the transmissivity of the pixels of the preceding line; in such a case, however, blurring occurs in some of the moving pictures.

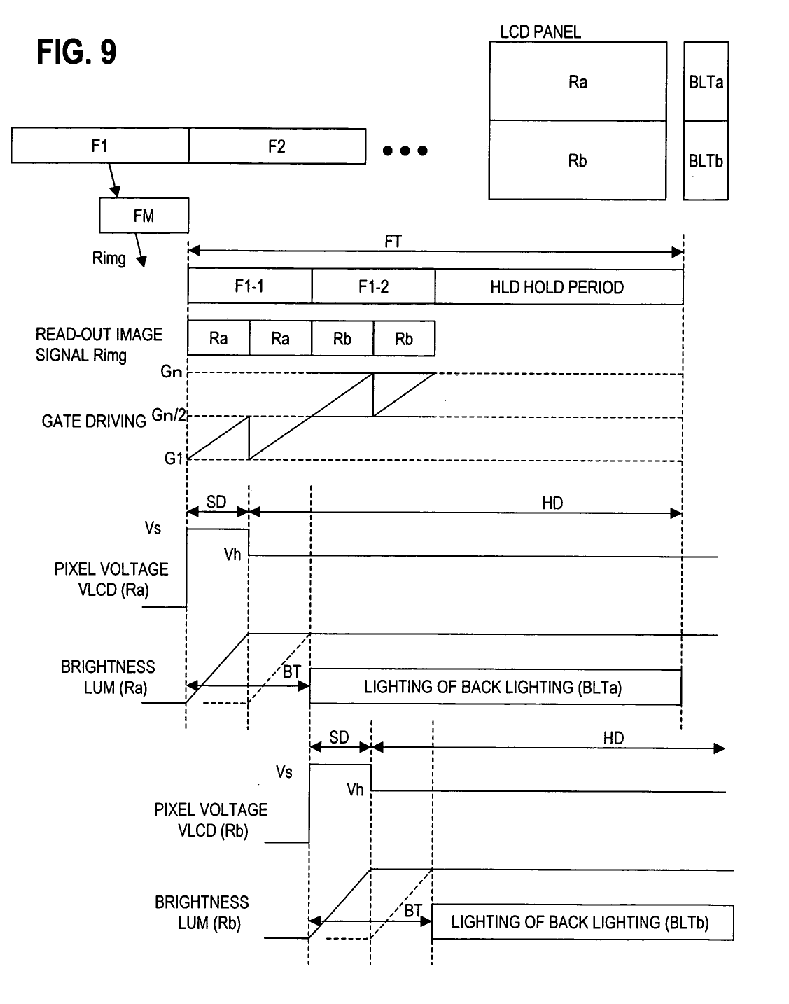

FIG. 9 is a diagram showing the second driving control of the liquid crystal display panel in the present embodiment. In this example as well, as is shown in the upper right portion of FIG. 8, the liquid crystal display panel is divided into first and second display regions Ra and Rb, and first and second back lighting units BLTa and BLTb are controlled by separate lighting control for these respective display regions.

Furthermore, in the initial ¼ of the frame period FT, start driving SD in which the pixels are driven by a start voltage Vs corresponding to the read-out image data Rimg while all of the gate lines G1 through Gn/2 of the first display region Ra are successively driven, and hold driving HD in which the pixels are driven by the hold voltage Vh while all of the gate lines G1 through Gn/2 of the first display region are again successively driven, are successively performed. Subsequently, in the next period equal to ¼ of the frame period, start driving SD in which the pixels are driven by a start voltage Vs corresponding to the read-out image data Rimg while all of the gate lines Gn/2 through Gn of the second display region Rb are successively driven, and hold driving HD in which the pixels are driven by the hold voltage Vh while all of the gate lines Gn/2 through Gn of the second display region Rb are again successively driven, are successively performed. In the latter half FT/2 of the frame period FT, the liquid crystal layer of all of the pixels is maintained at the hold voltage Vh.

Furthermore, lighting control of the respective back lighting units BLTa and BLTb is performed after the start driving SD of all of the pixels is completed in the respective display regions Ra and Rb. In other words, lighting of the back lighting unit BLTa for the region Ra is performed during a period of 3 FT/4 from the time of FT/4 in the frame period FT, and lighting of the back lighting unit BLTb for the region Rb is performed during a period of 3 FT/4 from the latter half of the frame period FT. As a result, the respective blurring periods BT can be shortened to a period of FT/4. As is clear from a comparison with the example of driving shown in FIG. 7, while the read-out speed from the frame memory and the transfer rate are the same quadrupled rates, the response speed of the liquid crystal is multiplied 8 times (the period of the start driving SD is FT/8), so that the blurring period BT becomes FT/4. Furthermore, in FIG. 7, the liquid crystal response speed is quadrupled, and the blurring period BT is 3 FT/8.

Thus, the display panel is separated into first and second display regions, the back lighting units BLTa and BLTb that supply transmitted light to the respective regions are controlled by separate lighting control, and start driving and hold driving are successively performed for the second display region after start driving and hold driving are successively performed for the first display region. As a result of such control being performed, it is possible to increase the response speed of the liquid crystal layer without increasing the read-out speed of the image data from the frame memory, and the blurring period BT including the transitional period in which the transmissivity of the liquid crystal layer varies can be shortened.

The driving control shown in FIGS. 8 and 9 can be realized by using a construction in which the liquid crystal display panel can be controlled by separate driving control for two display regions as in the gate driver 26 and back lighting 28a and 28b shown in FIG. 2. In other words, the gate driver 26 is divided into two shift registers 260 and 264, and start signals SSGa and SSGb are separately applied to the respective registers at a desired timing, so that the driving of the gate lines of the two display regions can be performed at the abovementioned timing. Accordingly, the end signal ESGa is not used as a start signal SSGb. Furthermore, image data for the desired display region is read out from the frame memory FM, and the read-out image data Rimg is successively supplied line by line to the data latch 240 of the data driver 24. Further, the driver control unit 22 determines image data corresponding to overdrive start voltage Vs and hold voltage Vh from the read-out image data Rimg, and successively supplies this image data line by line to the data latch 240 of the data driver 24. Furthermore, the driver control unit 22 sends back lighting driving signals to the two back lighting units 28a and 28b at a timing corresponding to the abovementioned control.

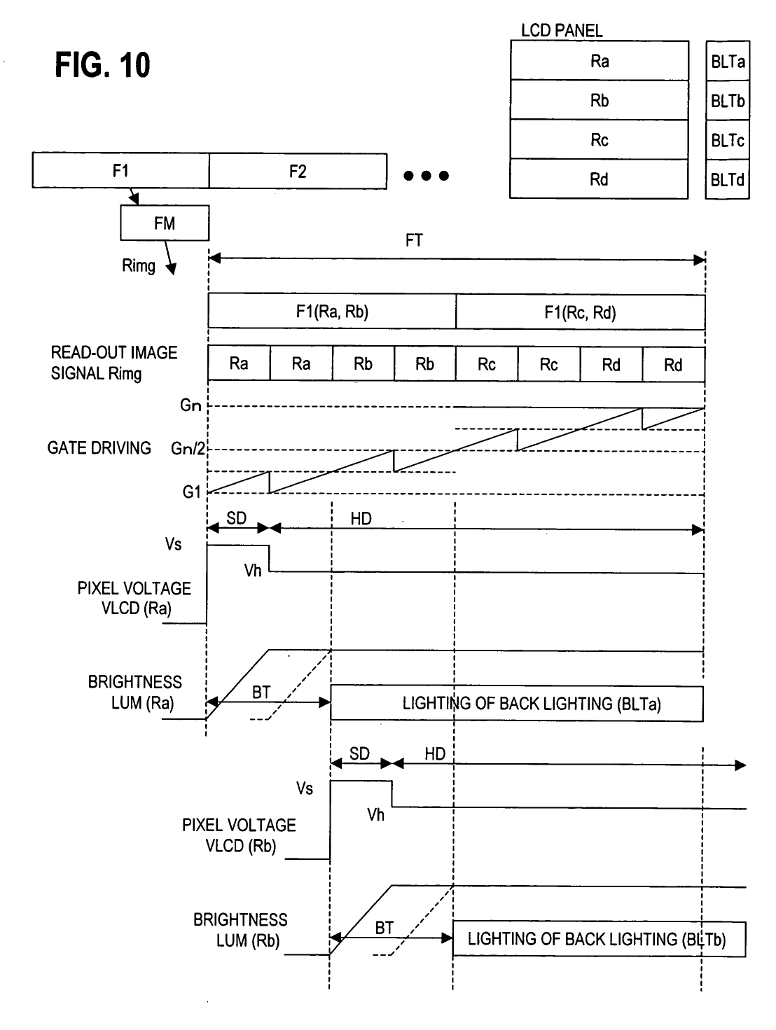

FIG. 10 is a diagram showing the third driving control of the liquid crystal display panel in the present embodiment. This example applied the first driving control shown in FIG. 8 to four divided display regions and back lighting. In other words, as is shown in the upper right portion of FIG. 10, the liquid crystal display panel is divided into first through fourth display regions Ra through Rd, and four back lighting units BLTa through BLTd are controlled by separate lighting control for these respective display regions.

In this driving control, in the former half of the frame period FT, the same driving control as that in FIG. 8 is performed for the first and second display regions Ra and Rb, and in the latter half of the frame period FT, the same driving control as that in FIG. 8 is performed for the third and fourth display regions Rc and Rd. In other words, in the initial ¼ period of the frame period FT, start driving SD in which the pixels are driven by a start voltage Vs corresponding to the read-out image data Rimg while all of the gate lines G1 through Gn/4 of the first display region Ra are successively driven, and hold driving HD in which the pixels are driven by the hold voltage Vh while all of the gate lines G1 through Gn/4 of the first display region Ra are again successively driven, are successively performed. The back lighting unit BLTa applied to the first display region Ra is lit during the period of 3 FT/4 following the completion of the start driving SD of all of the pixels within the first display region Ra.

In the next ¼ period, the start driving SD and hold driving HD of the second display region Rb are successively performed, and the back lighting unit BLTb that is applied to the second display region Rb is lit during the period of 3 FT/4 following the completion of the start driving SD of all of the pixels within the second display region Rb.

Then, in the next ¼ period, driving control of the third display region Rc and lighting control of the third back lighting unit BLTc are performed in the same manner as described above, and in the final ¼ period, driving control of the fourth display region Rd and lighting control of the fourth back lighting unit BLTd are performed in the same manner as described above.

Thus, in this example, the read-out of image data from the frame memory FM is successively performed in the order of the image data in the display regions Ra, Ra, Rb, Rb, Rc, Rc, Rd, Rd, and driving data corresponding to these sets of image data is transferred to the data driver.

In this case, while the read-out speed of the image data from the frame memory FM and the transfer rate of this data to the data driver remain doubled, the response speed of the liquid crystal layer can be increased eight times so that the blurring period BT can be shortened to FT/4. This is a merit that is obtained by dividing the back lighting into four parts, and controlling these back lightings separately.

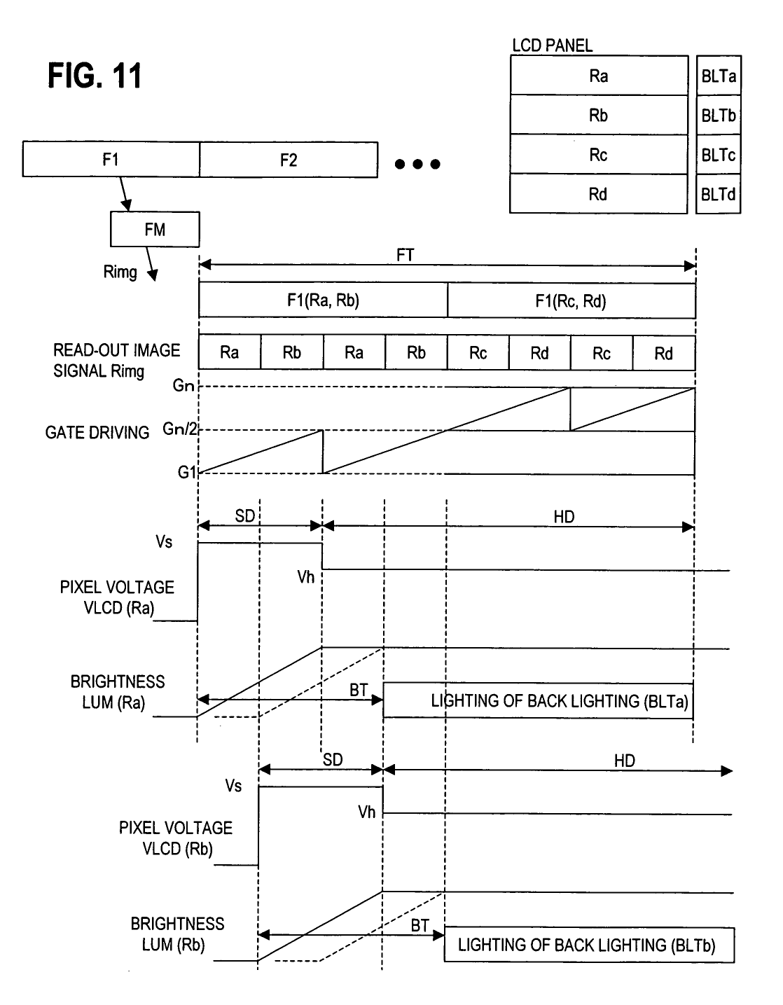

FIG. 11 is a diagram showing the fourth driving control of the liquid crystal display panel in the present embodiment. In this example, the following operation is performed in a construction in which the liquid crystal display panel is divided into four display regions and four back lighting units in the same manner as in FIG. 10: namely, in the former half of the frame period FT, start driving SD and hold driving HD are successively performed for the first and second display regions Ra and Rb, and in the latter half of the frame period FT, start driving SD and hold driving HD are successively performed for the third and fourth display regions Rc and Rd. Up to this point, this driving control is the same as the first driving control shown in FIG. 8. In other words, the read-out image signals Rimg and gate driving control are in the order RaRb, RaRb, RcRd, RcRd, and these are the same as Ra, Ra, Rb, Rb in FIG. 8.

In the case of FIG. 11, however, the back lighting can be controlled by separate lighting control corresponding to the four display regions. The first back lighting unit BLTa is lit at the point in time at which the start driving SD is completed for all of the pixels of the first display region Ra is completed, and the second back lighting unit IBLTb is lit at the point in time at which the start driving SD is completed for all of the pixels of the second display region Rb. A similar operation is also performed for the third and fourth display regions Rc and Rd.

Accordingly, the read-out speed of the image data from the frame memory FM and the transfer rate of this image data to the data driver are doubled as in the case of FIG. 8, and the response speed of the liquid crystal layer is also quadrupled as in FIG. 8. However, the driver control unit 22 controls the four back lighting units separately, and controls the lighting of the first back lighting unit BLTa after the start driving SD of all of the pixels of the first display region RA has been completed. In other words, the blurring period BT is shortened (to 3 FT/8) compared to FIG. 8, and the lighting period of the back lighting is increased by a corresponding amount (to 5 FT/8). Thus, even if the start driving SD and hold driving HD shown in FIG. 8 are employed, the blurring period BT can be shortened even further, and the lighting period of the back lighting can be lengthened even further, by dividing and controlling the back lighting more finely.

In the abovementioned third and fourth types of driving control, the liquid crystal display panel is divided into four display regions and four back lighting units, and these are separately controlled. Accordingly, the gate driver 26 shown in FIG. 2 has four sets of shift registers and driver circuits. The data driver 24 is the same as in FIG. 2.

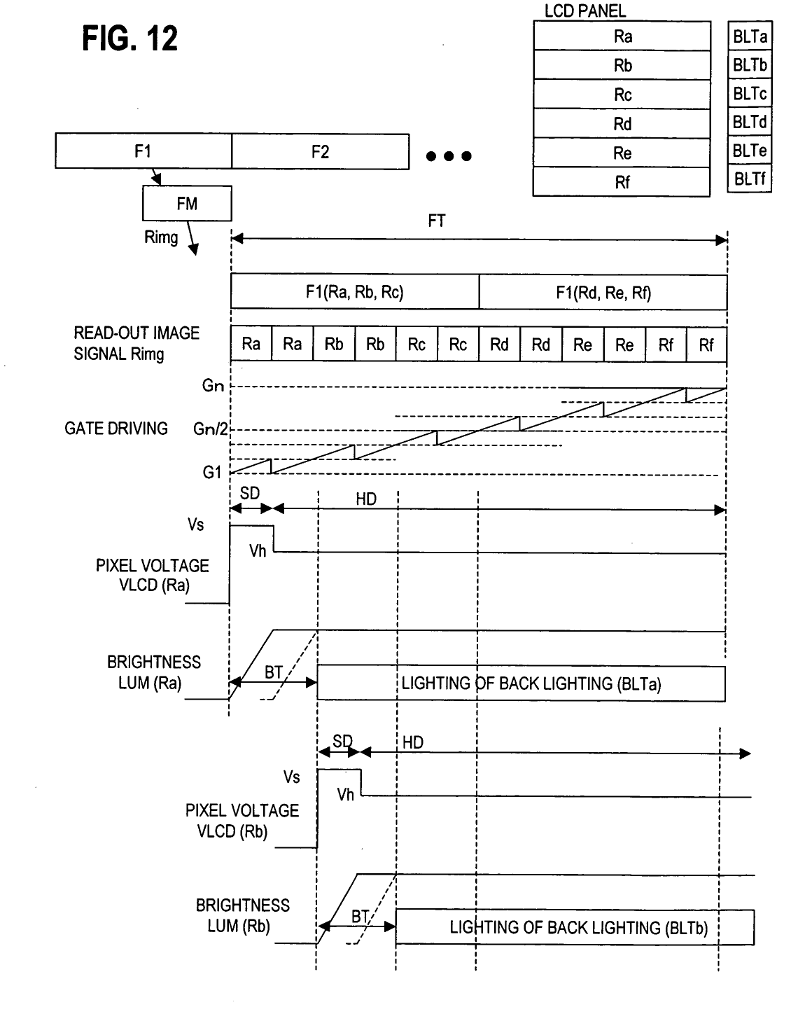

FIG. 12 is a diagram showing the fifth driving control in the present embodiment. In this fifth driving control, the liquid crystal display panel is divided into six display regions Ra through Rf, back lighting units BLTa through BLTf are provided for each of these display regions, and these back lighting units are controlled by separate lighting control. Specifically, this is an example in which the liquid crystal display panel is divided into six regions, and the driving control shown in FIGS. 8 and 10 is performed.

As is shown in FIG. 12, the driver control unit 22 successively performs start driving SD and hold driving HD for the six display regions Ra through Rf obtained by the abovementioned division. In other words, the readout of image data from the frame memory FM and transfer of this image data to the data driver, and the corresponding start driving and hold driving (SD/HD), are successively performed in the order Ra, Ra, Rb, Rb, Rc, Rc, Rd, Rd, Re, Re, Rf, Rf. Furthermore, the lighting of the back lighting unit BLT corresponding to each display region is controlled for a period of 5 FT/6 from the point in time at which the start driving of all of the pixels in this display region is completed until the next start driving is initiated.

In this driving control, the read-out speed and transfer rate of the image data are doubled, but the response speed of the liquid crystal is increased by a factor of 12, so that the blurring period BT is shortened to FT/6. Accordingly, an image display with a higher brightness can be performed.

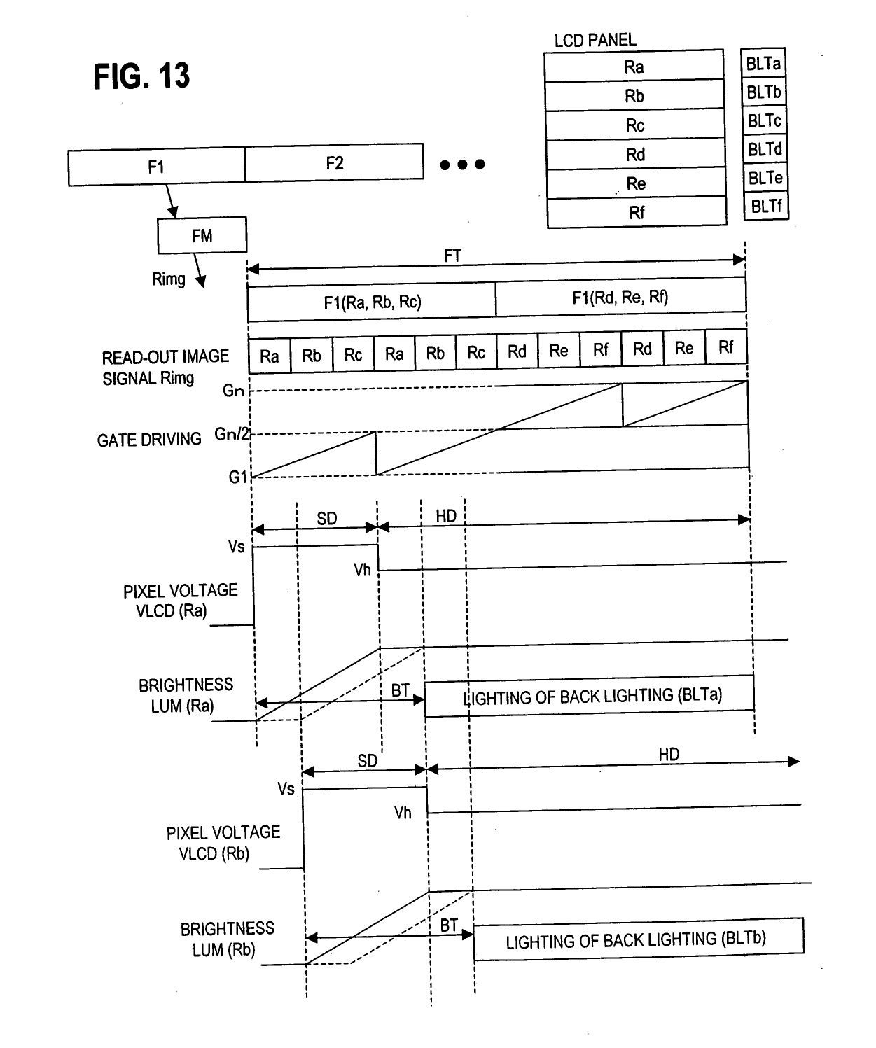

FIG. 13 is a diagram showing the sixth driving control in the present embodiment. In this sixth driving control, the liquid crystal display panel is divided into six display regions Ra through Rf, back lighting units BLTa through BLTf are provided for each of these display regions, and lighting control is performed separately. Specifically, this is an example in which the liquid crystal display panel is divided into six regions, and the driving control shown in FIG. 11 is performed.

As is shown in FIG. 13, the driver control unit 22 performs start driving SD and hold driving HD for Ra, Rb and Rc in the upper half of the liquid crystal display panel, and then performs start driving SD and hold driving HD for Rd, Re and Rf in the lower half of the liquid crystal display panel. Accordingly, the read-out speed and transfer rate of the image data are doubled, and the response speed of the liquid crystal layer is quadrupled. In this regard, this driving control is the same as the driving control shown in FIG. 11; in the example shown in FIG. 13, however, the blurring period BL is shortened to FT/3 (=8 F/24), and is thus shortened by FT/24 compared to the 3 FT/8 (=9 FT/24) in FIG. 11.

If a construction is used in which the liquid crystal display panel is divided into eight regions, and the system is devised so that the back lighting can be separately controlled for each of these display regions (in the same manner as described above), and if the system is further devised so that the start driving SD and hold driving HD are successively performed in the order Ra, Ra, Rb, Rb . . . in the same manner as described above, then the liquid crystal response speed can be increased at the same frame memory read-out speed and image data transfer rate, so that the blurring period BT can be shortened even further. Alternatively, it would also be possible to perform start driving SD for the upper half followed by hold driving for the upper half, and then to perform start driving SD for the lower half followed by hold driving for the lower half, as in Ra, Rb, Rc, Rd, Ra, Rb, Rc, Rd . . . . In this case, the liquid crystal response speed is not increased; however, the blurring period BT can be further shortened as a result of the finer division and separate driving of the back lighting.

What is claimed is:

1. A liquid crystal display device in which a voltage corresponding to image data is applied to a liquid crystal layer for each frame so that a transmissivity of said liquid crystal layer is varied to a transmissivity that corresponds to said image data, comprising:
a liquid crystal display panel which contains said liquid crystal layer, and which also has a plurality of gate lines, a plurality of data lines, and pixels at intersection positions of said gate lines and data lines;
back lighting which supplies light that passes through said liquid crystal layer; and
a liquid crystal control circuit unit which has a frame memory that stores image data corresponding to said frame, and which reads out image data from the frame memory and applies a voltage corresponding to the image data to the liquid crystal layer of pixels via said data lines;
wherein said back lighting has first and second back lighting units which respectively supply light to a first display region that has first gate lines of said liquid crystal display panel, and a second display region that has second gate lines of said liquid crystal display panel,
wherein said liquid crystal control circuit unit performs, during the frame period, start driving that drives the pixels at a first voltage corresponding to said image data, and hold driving that drives the pixels at a second voltage corresponding to said image data, successively for said first display region, and then performs said start driving and hold driving successively for said second display region, and
wherein the liquid crystal control circuit unit lights said first back lighting unit at the same time of or later than the end of the start driving in said first display region, and lights said second back lighting unit at the same time of or later than the end of the start driving in said second display region.

2. A liquid crystal display device in which a voltage corresponding to image data is applied to a liquid crystal layer for each frame so that a transmissivity of said liquid crystal layer is varied to a transmissivity that corresponds to said image data, comprising:
a liquid crystal display panel which contains said liquid crystal layer, and which also has a plurality of gate lines, a plurality of data lines, and pixels at intersection positions of said gate lines and data lines;
back lighting which supplies light that passes through said liquid crystal layer; and
a liquid crystal control circuit unit which has a frame memory that stores image data corresponding to said frame, and which reads out image data from the frame memory and applies a voltage corresponding to the image data to the liquid crystal layer of pixels via said data lines;
wherein said back lighting has first and second back lighting units which respectively supply light to a first display region that has first gate lines of said liquid crystal display panel, and a second display region that has second gate lines of said liquid crystal display panel,
wherein said liquid crystal control circuit unit performs, during the driving period within the frame period, start driving that drives the pixels at a first voltage corresponding to said image data, and hold driving that drives the pixels at a second voltage corresponding to said image data, successively for said first display region, and then performs said start driving and hold driving successively for said second display region, said first back lighting unit is lit at the same time of or later than the end of the start driving in said first display region, and said second back lighting unit is lit at the same time of or later than the end of the start driving in said second display region, and
wherein the liquid crystal control circuit unit further holds the voltages of the pixels of said first and second display regions during a holding period at the same time of or later than the end of the start driving period within the frame period.

3. The liquid crystal display device according to claim 1, wherein said liquid crystal control circuit unit does not light the first back lighting unit during the start driving in said first display region, and does not light the second back lighting unit during the start driving in said second display region.

4. The liquid crystal display device according to claim 2, wherein said liquid crystal control circuit unit does not light the first back lighting unit during the start driving in said first display region, and does not light the second back lighting unit during the start driving in said second display region.

5. The liquid crystal display device according to claim 1, wherein said first voltage is an overdrive voltage that accelerates the variation in the transmissivity of said liquid crystal, and said second voltage is a hold voltage that holds the transmissivity of said liquid crystal.

6. The liquid crystal display device according to claim 2, wherein said first voltage is an overdrive voltage that accelerates the variation in the transmissivity of said liquid crystal, and said second voltage is a hold voltage that holds the transmissivity of said liquid crystal.

7. The liquid crystal display device according to claim 1, wherein said liquid crystal control circuit unit drives said data lines at said first and second voltages while successively driving the gate lines within the corresponding first and second display regions in said start driving and hold driving.

8. The liquid crystal display device according to claim 2, wherein said liquid crystal control circuit unit drives said data lines at said first and second voltages while successively driving the gate lines within the corresponding first and second display regions in said start driving and hold driving.

9. A liquid crystal display device in which a voltage corresponding to image data is applied to a liquid crystal layer for each frame so that a transmissivity of said liquid crystal layer is varied to a transmissivity that corresponds to said image data, comprising:
a liquid crystal display panel which contains said liquid crystal layer, and which also has a plurality of gate lines, a plurality of data lines, and pixels at intersection positions of said gate lines and data lines;
back lighting which supplies light that passes through said liquid crystal layer; and
a liquid crystal control circuit unit which has a frame memory that stores image data corresponding to said frame, and which reads out image data from the frame memory and applies a voltage corresponding to the image data to the liquid crystal layer of pixels via said data lines;
wherein said back lighting has first through fourth back lighting units that respectively supply light to a first display region that has first gate lines of said liquid crystal display panel, a second display region that has second gate lines, a third display region that has third gate lines, and a fourth display region that has fourth gate lines,
wherein said liquid crystal control circuit unit performs, during the frame period, start driving that drives the pixels at a first voltage corresponding to said image data, and hold driving that drives the pixels at a second voltage corresponding to said image data, successively for said first display region, then performs said start driving and hold driving successively for said second display region, then performs said start driving and hold driving successively for said third display region, and then performs said start driving and hold driving successively for said fourth display region, and the first through fourth back lighting units are respectively lit at the same time of or later than the end of the respective start driving in said first through fourth display regions.

10. The liquid crystal display device according to claim 9, wherein said liquid crystal control circuit unit lights the first back lighting unit following the start driving in said first display region, lights the second back lighting unit following the start driving in said second display region, lights the third back lighting unit following the start driving in said third display region, and lights the fourth back lighting unit at the same time of or later than the end of the start driving in said fourth display region.

11. The liquid crystal display device according to claim 9, wherein said liquid crystal control circuit unit does not perform lighting of the first through fourth back lighting units during the start driving in said first through fourth display regions respectively.

12. The liquid crystal display device according to claim 10, wherein said liquid crystal control circuit unit does not perform lighting of the first through fourth back lighting units during the start driving in said first through fourth display regions respectively.

13. The liquid crystal display device according to claim 9, wherein said first voltage is an overdrive voltage that accelerates the variation in the transmissivity of said liquid crystal, and said second voltage is a hold voltage that holds the transmissivity of said liquid crystal.

14. The liquid crystal display device according to claim 9, wherein said liquid crystal control circuit unit drives said data lines at said first and second voltages while successively driving the gate lines within the corresponding first and second display regions in said start driving and hold driving.

15. A liquid crystal display device in which a voltage corresponding to image data is applied to a liquid crystal layer for each frame so that a transmissivity of said liquid crystal layer is varied to a transmissivity that corresponds to said image data, comprising:
a liquid crystal display panel which contains said liquid crystal layer, and which also has a plurality of gate lines, a plurality of data lines, and pixels at intersection positions of said gate lines and data lines;
back lighting which supplies light that passes through said liquid crystal layer; and
a liquid crystal control circuit unit which has a frame memory that stores image data corresponding to said frame, and which reads out image data from the frame memory and applies a voltage corresponding to the image data to the liquid crystal layer of pixels via said data lines;
wherein said back lighting has first through fourth back lighting units that respectively supply light to a first display region that has first gate lines of said liquid crystal display panel, a second display region that has second gate lines, a third display region that has third gate lines, and a fourth display region that has fourth gate lines,
wherein said liquid crystal control circuit unit performs, during the frame period, start driving that drives the pixels at a first voltage corresponding to said image data, and hold driving that drives the pixels at a second voltage corresponding to said image data, successively for said first and second display regions, and then performs said start driving and hold driving successively for said third and fourth display regions, and the first through fourth back lighting units are respectively lit at the same time of or later than the end of the respective start driving in said first through fourth display regions.

16. The liquid crystal display device according to claim 15, wherein said liquid crystal control circuit unit lights the first back lighting unit at the same time of or later than the end of the start driving in said first display region, lights the second back lighting unit at the same time of or later than the end of the start driving in said second display region, lights the third back lighting unit at the same time of or later than the end of the start driving in said third display region, and lights the fourth back lighting unit at the same time of or later than the end of the start driving in said fourth display region.

17. The liquid crystal display device according to claim 15, wherein said liquid crystal control circuit unit does not perform lighting of the first through fourth back lighting units during the start driving in said first through fourth display regions respectively.

18. The liquid crystal display device according to claim 16, wherein said liquid crystal control circuit unit does not perform lighting of the first through fourth back lighting units during the start driving in said first through fourth display regions respectively.

19. The liquid crystal display device according to claim 15, wherein said first voltage is an overdrive voltage that accelerates the variation in the transmissivity of said liquid crystal, and said second voltage is a hold voltage that holds the transmissivity of said liquid crystal.

20. The liquid crystal display device according to claim 15, wherein said liquid crystal control circuit unit drives said data lines at said first and second voltages while successively driving the gate lines within the corresponding first and second display regions in said start driving and hold driving.

21. A liquid crystal display device in which a voltage corresponding to image data is applied to a liquid crystal layer for each frame so that a transmissivity of said liquid crystal layer is varied to a transmissivity that corresponds to said image data, comprising:
a liquid crystal display panel which contains said liquid crystal layer, and which also has a plurality of gate lines, a plurality of data lines, and pixels at intersection positions of said gate lines and data lines;
first and second back lighting units which respectively supply light to the liquid crystal layer of a first display region that has first gate lines of the liquid crystal display panel, and the liquid crystal layer of a second display region that has second gate lines; and
a liquid crystal control circuit unit which applies a voltage corresponding to the image data to the liquid crystal layer of pixels via said data lines;
wherein said liquid crystal control circuit unit performs, during the frame period, start driving that drives the pixels at a first voltage corresponding to said image data, and hold driving that drives the pixels at a second voltage corresponding to said image data, successively for said first display region, and then performs said start driving and hold driving successively for said second display region, and said first back lighting unit is lit at the same time of or later than the end of the start driving in said first display region, while said second back lighting unit is lit at the same time of or later than the end of the start driving in said second display region.
